(19) United States
(12) Patent Application Publication
(10) Pub. No.: US 2002/0026387 A1
(43) Pub. Date: Feb. 28, 2002

(54) Commodity selling system for storing and displaying the information of purchase candidate commodity

(76) Inventors: Hisashi Tanaka, Tokyo (JP); Katsumi Sasaki, Tokyo (JP)

Correspondence Address: McGuire Woods, Suite 1800, 1750 Tysons Boulevard, Tysons Corner, VA, 22101-4215, US

(21) Appl. No.: 09/901,621

(22) Filed: Jul. 11, 2001

(30) Foreign Application Priority Data
Jul. 14, 2000 (JP) 2000-214776

(51) Int. Cl. G06F 17/60

(52) U.S. Cl. 705/27

(57) ABSTRACT

A commodity selling system is disclosed for performing online shopping through a network such as the Internet. The commodity selling system includes a seller server. the seller server stores information on each purchase candidate commodity selected by the user as a candidate for purchase. With the storage of the information on each purchase candidate commodity, the information can be displayed on a purchase candidate commodity list when the user attempts to determine which commodities to purchase at some future date. The user can determine which commodity to purchase on the basis of the displayed information and need not customize the purchase candidate commodity again.

### BACKGROUND OF THE INVENTION

1. Field of the Invention

The present invention relates to a commodity selling system and method for performing online shopping through a network, and more particularly to a commodity selling system and method having a support function for allowing a user to determine which commodity to purchase.

2.Description of the Related Art

In recent years, online shopping has come into use, in which a user of a network such as the Internet can access a Web page selling commodities from his or her personal computer and purchase these commodities online.

FIG. 1 is a block diagram showing a configuration of a conventional commodity selling system for performing online shopping through a network. A user accesses a Web page 15 of seller server 11 through network 20 by using user terminal 30, views information such as the names, specifications, or prices of commodities appearing on the Web page, and then determines which commodity to purchase.

In recent commodity selling systems, basic specifications of a commodity to purchase can be customized or some options can be added thereto.

However, it is necessary for a user to view a plurality of commodities when he or she attempts to determine which commodity to purchase, or a sufficient budget for purchase is not ensured sometimes when he considers purchasing a commodity. Thus, a user seldom purchases a commodity immediately after customization of the basic specifications of the commodity or addition of some options, but often determines which commodity to purchase after he or she further views other information such as models to pick up several candidate commodities for purchase or at some future date. In this case, when the user attempts to view the information on purchase candidate commodities picked up the last time as purchase candidates to determine which commodity to purchase, he or she must customize the basic specifications of the commodity or add options again.

In addition, in the aforementioned commodity selling system, prices of commodities sometimes vary according to the trend of the market and options to be added may be changed. Accordingly, even if customization of basic specifications of a commodity to be purchased and selected options are recorded by printing or the like the last time, a user must check whether the conditions of each commodity selected as a candidate for purchase remain the same.

### SUMMARY OF THE INVENTION

It is an object of the present invention to provide a commodity selling system capable of reducing burden on a user when the user determines which commodity to purchase from commodities appearing on a Web page.

To achieve the aforementioned object, according to one aspect of the invention, the commodity selling system of comprises a user terminal used by a user for connection to a network, and a seller server for storing information on each purchase candidate commodity at the time when said each purchase candidate commodity is selected from said commodities appearing on said Web page, and displaying said information on said user terminal in response to a request from said user terminal.

The commodity selling system of the present invention stores the information on each purchase candidate commodity selected from the commodities appearing on the Web page Thus, a user can make determination of which commodity to purchase at some future date on the basis of the stored information, and the user need not customize a purchase candidate commodity on the Web page of the seller server again. As a result, it is possible to reduce burden on the user.

According to another aspect of the present invention, when the seller server displays the information on the user terminal in response to a request from the user terminal, the seller server also displays information which occurred in relation to the purchase candidate commodity from the selection of the purchase candidate commodity to now on the user terminal together with the information.

In the commodity selling system of the present invention, the information which occurred in relation to a purchase candidate commodity from the selection of the purchase candidate commodity to now is also displayed on the user terminal, thereby allowing a user to always make a final determination of which commodity to purchase on the basis of new information.

The above and other objects, features and advantages of the present invention will become apparent from the following description with reference to the accompanying drawings which illustrate examples of the present invention.

### BRIEF DESCRIPTION OF THE DRAWINGS

FIG. 1 is a block diagram showing a configuration of a conventional commodity selling system;

FIG. 2 is a block diagram showing a configuration of a commodity selling system according to an embodiment of the present invention; and

FIG. 3 shows a commodity selling sequence in the commodity selling system shown in FIG. 2.

### DETAILED DESCRIPTION OF THE PREFERRED EMBODIMENT

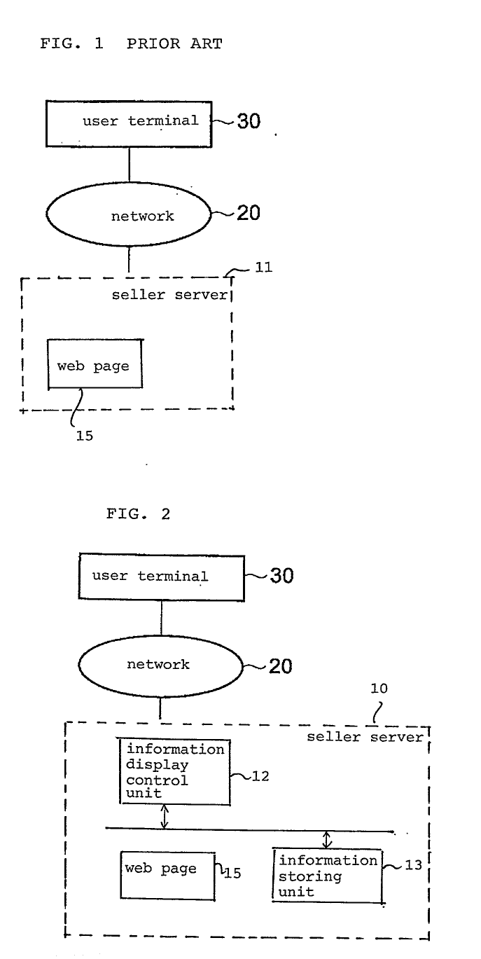

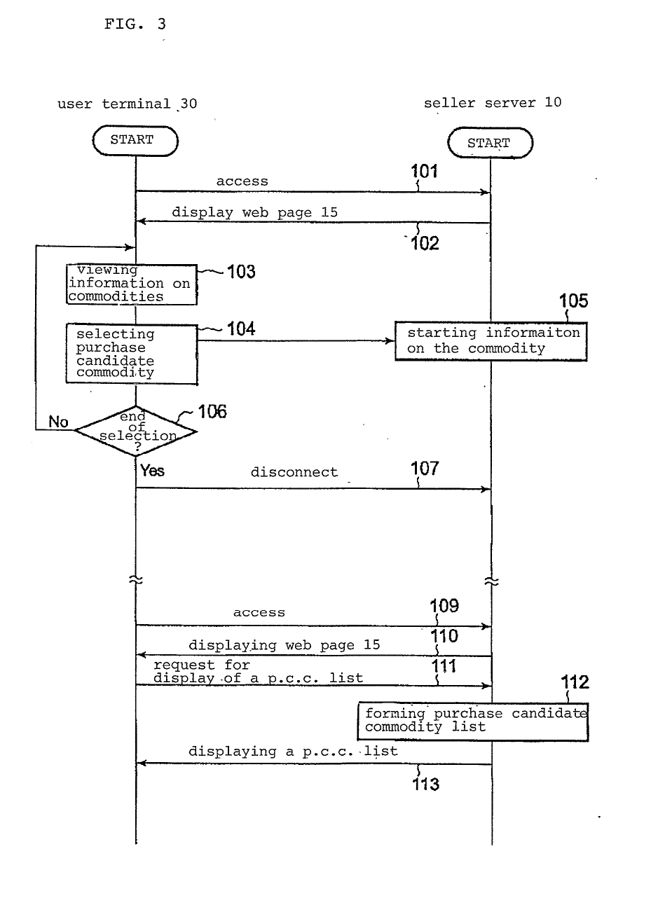

As shown in FIG. 2, the commodity selling system according to the embodiment differs from the conventional commodity selling system as shown in FIG. 1 in that it comprises seller server 10 instead of seller server 11.

Seller server 10 comprises a Web page 15 for performing online shopping similarly to seller server 11. In addition, seller server 10 comprises information display control unit 12 and information storing unit 13. Information display control unit 12 and information storing unit 13 are connected to each other through an internal bus.

Information display control unit 12 displays information on user terminal 30 in response to a request from user terminal 30. Information storing unit 13 stores information on each purchase candidate commodity at the time when each purchase candidate commodity is selected from commodities on Web page 15. Information display control unit 12 and information storing unit 13 in seller server 10 may be implemented by dedicated hardware, or may be formed of a memory and a CPU (Central Processing Unit) such that the functions thereof may be realized by loading a program for realizing the functions of the aforementioned respective units into the memory and executing the program.

Table 1 shows an example of the list of purchase candidate commodities in the commodity selling system of the embodiment. As shown in Table 1, the list of purchase candidate commodities includes information on each commodity at the time of selection as a purchase candidate commodity such as the name, number, delivery date, estimation, customized specifications, and added options of each selected purchase candidate commodity. The list also includes the latest information which occurred in relation to each commodity from the selection of the commodity as a purchase candidate commodity to now such as current inventory information on the purchase candidate commodity, information on changes in delivery date or price, information such as update, or information on other new produces associated with the commodity.

TABLE 1

| | | | delivery | | |
|---|---|---|---|---|---|
| No. | name | number | date | price | information |
| 1 | ∘∘∘∘∘∘ | 1 | 5, July | ¥495,000 | 10 items of stock |
| 2 | xxxxxx | 1 | 21, July | ¥395,000 | in stock |
| 3 | ΔΔΔΔΔΔ | 2 | 1, August | ¥197,000 | It is possible to |
| | | | | | hasten a delivery |
| | | | | | date |
| 4 | — | — | — | — | — |

In the commodity selling system of the embodiment, a user can always make a final determination of which commodity to purchase on the basis of new information by including the latest information on the purchase candidate commodities on the purchase candidate commodity list. In addition, seller server 10 can display the purchase candidate commodity list on user terminal 30 at any time when the user requests such display.

Next, the commodity selling sequence will be explained with reference to FIG. 3. At step 101, a user first accesses seller server 10 through user terminal 30. At step 102, seller server 10 then displays a Web page 15 for online shopping on user terminal 30. At step 103, the user views detailed information on commodities appearing on the displayed Web page 15, and selects a purchase candidate commodity from the commodities at step 104. The selected purchase candidate commodity is transmitted to seller server 10 which stores the information on the commodity at step 105. The operations from step 103 to step 106 are repeated until the selection of purchase candidate commodities is completed. Then, even if the user disconnects the access to seller server 10 at step 107, the information on the purchase candidate commodities remains stored in seller server 10.

Thereafter, when the user again accesses seller server 10 from user terminal 30 at step 109, seller server 10 displays the Web page 15 on user terminal 30 at step 110. In response to a request for display of a purchase candidate commodity list transmitted from user terminal 30 at step 111, seller server 10 forms a purchase candidate commodity list of the stored information and the latest information on the purchase candidate commodities at step 112, and displays the purchase candidate commodity list having the latest information added thereto on user terminal 30 at step 113.

As described above, the commodity selling system of the embodiment stores the information on the purchase candidate commodities selected from the commodities appearing on the Web page 15. This allows the user to determine which commodity to purchase on the basis of the stored information in making a determination of a commodity to be purchased at some future date. In addition, the user need not customize a purchase candidate commodity selected from the commodities on Web page 15 of seller server 10 again. It is thus possible to reduce burden on the user when the user determines which commodity to purchase.

While a preferred embodiment of the present invention has been described using specific terms, such description is for illustrative purposes only, and it is to be understood that changes and variations may be made without departing from the spirit or scope of the following claims.

What is claimed is:

1. A commodity selling system for allowing a user to purchase commodities through a network, said system comprising:
a user terminals each used by a user for connection to the network; and
a seller server for storing information on each purchase candidate commodity at the time when said each purchase candidate commodity is selected from said commodities appearing on said Web page, and for displaying said information on said user terminal in response to a request from said user terminal.

2. The commodity selling system according to claim 1, wherein said seller server includes means, when displaying said information on said user terminal in response to a request from said user terminal, for also displaying information which have been generated in relation to said purchase candidate commodity from the time of the selection of said purchase candidate commodity to now on said user terminal together with said information.

3. A seller server for use in a commodity selling system, said seller server comprising:
a web page accessible from user terminals through the network;
an information storing means for storing information on each purchase candidate commodity at the time when said each purchase candidate commodity is selected from said commodities on- said Web page; and
an information display control means for displaying said information on said user terminal in response to a request from said user terminal.

4. The seller server according to claim 3, wherein said information display control mean also displays information which have been generated in relation to said purchase candidate commodity from the time of the selection of said purchase candidate commodity to now on said user terminal together with said information.

5. A method of selling online commodities appearing on a Web page of a seller server, the server being accessible from user terminals through a network, said method comprising the steps of:
storing, in said seller server, information on each purchase candidate commodity at the time when said each purchase candidate commodity is selected from said commodities appearing on said Web page; and
displaying said information on said user terminal in response to a request from said user terminal.

6. The method of selling commodities according to claim 5, further comprising the step of displaying, when said information is displayed on said user terminal in response to a request from said user terminal, information which have been generated in relation to said purchase candidate commodity from the time of the selection of said purchase candidate commodity to now.

7. A computer program for enabling a computer to execute selling online commodities appearing on a Web page of a seller server, the server accessible from a user terminal through a network, said program comprising:
a first set of instructions of storing, in said seller server, information on each purchase candidate commodity at the time when said each purchase candidate commodity is selected from commodities appearing on a web page; and
a second set of instructions of displaying said information on a user terminal in response to a request from said user terminal.

8. The program according to claim 7, wherein said processing further comprises displaying, when said information is displayed on said user terminal in response to a request from said user terminal, information which have been generated in relation to said purchase candidate commodity from the time of the selection of said purchase candidate commodity to now on said user terminal together with said information.
